(19) United States
(12) Patent Application Publication
(10) Pub. No.: US 2018/0333739 A1
(43) Pub. Date: Nov. 22, 2018

(54) COATING DEVICE AND METHOD OF PRODUCING COATED SHEET

(71) Applicants: SUMITOMO ELECTRIC INDUSTRIES, LTD., Osaka-shi, Osaka (JP); SUMITOMO ELECTRIC PRINTED CIRCUITS, INC., Koka-shi, Shiga (JP)

(72) Inventors: Kazuhiro MIYATA, Osaka-shi, Osaka (JP); Takashi KASUGA, Osaka-shi, Osaka (JP); Yoshio OKA, Osaka-shi, Osaka (JP); Yasuhiro OKUDA, Osaka-shi, Osaka (JP); Jinjoo PARK, Koka-shi, Shiga (JP); Hiroshi UEDA, Koka-shi, Shiga (JP); Kohei OKAMOTO, Koka-shi, Shiga (JP)

(73) Assignees: SUMITOMO ELECTRIC INDUSTRIES, LTD., Osaka-shi, Osaka (JP); SUMITOMO ELECTRIC PRINTED CIRCUITS, INC., Koka-shi, Shiga (JP)

(21) Appl. No.: 15/776,813

(22) PCT Filed: Nov. 10, 2016
(86) PCT No.: PCT/JP2016/083379

§ 371 Date: May 17, 2018

(30) Foreign Application Priority Data
Nov. 19, 2015 (JP) 2015-227069

(51) Int. Cl. B05C 5/02; B05D 1/26; B05C 11/10

(52) U.S. Cl. CPC B05C 5/0254; B05C 11/10; B05C 5/0208; B05D 1/26

(57) ABSTRACT

A coating device according to an aspect of the present invention includes a travel module that causes a strip-shaped sheet to travel in a longitudinal direction, a coating module that coats a surface of the strip-shaped sheet with ink while the strip-shaped sheet travels, and a supply module that supplies the ink to the coating module. The coating module includes a slot-type coating head that is disposed above the strip-shaped sheet so as to span the strip-shaped sheet in a width direction. The slot-type coating head includes an ink storage part that widens toward the strip-shaped sheet in cross-sectional view and an ink supply path that communicates with an upper part of the ink storage part.

### TECHNICAL FIELD

The present invention relates to a coating device and a method of producing a coated sheet. The present application claims priority over Japanese Patent Application No. 2015-227069, filed on Nov. 19, 2015, the entire contents of which are incorporated herein by reference.

### BACKGROUND ART

For example, a process of producing an optical sheet or a flexible printed circuit board may include a step of coating an elongated sheet with ink. Examples of a known coating device (coater) used in the coating step include a slot-type coater that uses a die having an ink ejection slot, a gravure-type coater that uses a gravure roll that forms a thin film of ink on a surface thereof and transfers the ink to a sheet, and a bar-type coater that uses a bar-shaped member (doctor) that wipes off residual ink on a sheet surface.

A general slot-type coater supplies ink to a die, and pushes the ink out of a slot in the die. Therefore, ink is not likely to contact air before the coating step. However, the exiting slot-type coater can be used for inks having physical properties in a narrow range, and it is difficult for the coater to perform coating with ink having a comparatively low viscosity of, for example, about several mPa·s. On the other hand, the gravure-type coater and the bar-type coater can be used to perform coating with inks having physical properties in a wide range and can perform coating with ink having a low viscosity. However, because the gravure-type coater and the bar-type coater form an air-released liquid reservoir, the quality of ink tends to degrade.

As a concrete example, the gravure-type coater stores ink in an air-released liquid receiver pan, immerses a coating roll in the ink, and thereby places the ink on a peripheral surface of the coating roll. Therefore, the properties of ink considerably vary with time in the liquid receiver pan of the gravure-type coating machine. To be specific, water in the air dissolves into ink in the liquid receiver pan to cause gelation of the ink, and therefore a defect in a coating film tends to occur.

To address such a problem, there has been proposed a gravure coating apparatus including a circulation system and an automatic analyzing device. The circulation system circulates ink in a liquid receiver pan while adding an ink component from an additional-liquid tank in order to keep the quality of ink constant (see Japanese Unexamined Patent Application Publication No. 2013-71109). The automatic analyzing device samples ink in the liquid receiver pan and analyzes the ink, and, on the basis of the result of the analysis, the gravure coating apparatus adjusts the amount of the ink component added to ink that is circulated by the circulation system.

### CITATION LIST

### Patent Literature

PTL 1: Japanese Unexamined Patent Application Publication No. 2013-71109

The gravure coating apparatus described in PTL 1 can keep the quality of ink constant for a predetermined time by adjusting the amount of the ink component added to the circulating ink from the additional-liquid tank. However, because the circulating ink is air released in the liquid receiver pan, degradation of the quality of ink cannot be completely suppressed. After the predetermined time has elapsed, the quality of ink cannot be kept constant by adding the ink component from the additional-liquid tank.

### SUMMARY OF INVENTION

### Solution to Problem

A coating device according to an aspect of the present invention, which has been devised to solve the problem described above, includes a travel module that causes a strip-shaped sheet to travel in a longitudinal direction, a coating module that coats a surface of the strip-shaped sheet with ink while the strip-shaped sheet travels, and a supply module that supplies the ink to the coating module. The coating module includes a slot-type coating head that is disposed above the strip-shaped sheet so as to span the strip-shaped sheet in a width direction. The slot-type coating head includes an ink storage part that widens toward the strip-shaped sheet in cross-sectional view and an ink supply path that communicates with an upper part of the ink storage part.

A method of producing a coated sheet according to another aspect of the present invention includes a step of coating a surface of a strip-shaped sheet with ink by using the coating device described above.

### BRIEF DESCRIPTION OF DRAWINGS

FIG. 1 is a schematic sectional view of a coating device according to a first embodiment of the present invention.

FIG. 2 is a schematic plan view of the coating device of FIG. 1.

FIG. 3 is a schematic sectional view illustrating inclination of the travel direction of a strip-shaped sheet in the coating device of FIG. 1.

FIG. 4 is a schematic sectional view of a coating device according to a second embodiment of the present invention.

FIG. 5 is a schematic sectional view of a coating device according to a third embodiment of the present invention.

FIG. 6 is a schematic sectional view of a coating device according to a fourth embodiment of the present invention.

FIG. 7 is a schematic sectional view of a coating device according to a fifth embodiment of the present invention.

FIG. 8 is a schematic sectional view of a coating device according to a sixth embodiment of the present invention.

### DESCRIPTION OF EMBODIMENTS

### Problems to be Solved by the Present Disclosure

An object of the present invention, which has been devised against the background described above, is to provide a coating device and a method of producing a coated sheet each of which can perform coating with ink having a comparatively low viscosity and that can suppress degradation of the quality of ink.

### Advantages Effects of the Invention

A coating device and a method of producing a coated sheet according to the present invention can perform coating with ink having a comparatively low viscosity and can suppress degradation of the quality of ink.

### Description of Embodiments of the Present Invention

A coating device according to an aspect of the present invention includes a travel module that causes a strip-shaped sheet to travel in a longitudinal direction, a coating module that coats a surface of the strip-shaped sheet with ink while the strip-shaped sheet travels, and a supply module that supplies the ink to the coating module. The coating module includes a slot-type coating head that is disposed above the strip-shaped sheet so as to span the strip-shaped sheet in a width direction. The slot-type coating head includes an ink storage part that widens toward the strip-shaped sheet in cross-sectional view and an ink supply path that communicates with an upper part of the ink storage part.

In the coating device, the slot-type coating head includes the ink storage part that widens toward the strip-shaped sheet in cross-sectional view. Therefore, the coating device does not adjust the thickness of a coating film by controlling the amount of ink supplied to the slot-type coating head. Instead, the coating device can adjust the thickness of a layer of ink that is drawn out in accordance with travelling of the surface of the strip-shaped sheet by using a part of the ink storage part of the slot-type coating head on the downstream side in the travel direction of the strip-shaped sheet as a doctor. Therefore, the coating device can perform coating with ink having a comparatively low viscosity. Moreover, the coating device can suppress degradation of the quality of ink, because the coating device can reduce contact between ink and air by supplying ink into the ink storage part that is closed.

Preferably, the slot-type coating head includes a pair of bar-shaped members that are disposed parallel to each other and in such a way that upper parts thereof are adjacent to each other, and a gap between the pair of bar-shaped members forms the ink storage part and the ink supply path. In this case, where the slot-type coating head includes a pair of bar-shaped members that are disposed parallel to each other and in such a way that upper parts thereof are adjacent to each other and a gap between the pair of bar-shaped members forms the ink storage part and the ink supply path, the slot-type coating head can be designed and formed comparatively easily. The term “cross section” refers to a section perpendicular to the span direction of the slot-type coating head.

Preferably, at least one of the pair of bar-shaped members has a plurality of grooves in at least a lower part thereof, the grooves being parallel to a travel direction of the strip-shaped sheet. In this case, where at least one of the pair of bar-shaped members has a plurality of grooves in at least a lower part thereof, the grooves being parallel to a travel direction of the strip-shaped sheet, travelling resistance applied to the strip-shaped sheet by the slot-type coating head is reduced and travelling of the strip-shaped sheet can be stabilized. Thus, the thickness of a coating film formed on the surface of the strip-shaped sheet can be easily adjusted, and the coating film can be easily formed so as to have a uniform thickness. The phrase “parallel to a travel direction” means having an angle, relative to the travel direction, of 20° or smaller, preferably 10° or smaller, and more preferably 5° or smaller.

Preferably, at least one of the pair of bar-shaped members has an inclined surface at an upper part thereof, the inclined surface being inclined at an angle of depression in a direction toward the other bar-shaped member. In this case, where at least one of the pair of bar-shaped members has an inclined surface at an upper part thereof, the inclined surface being inclined at an angle of depression in a direction toward the other bar-shaped member, ink can be supplied to the ink supply path along the inclined surface and therefore ink can be supplied comparatively easily.

Preferably, the supply module includes a nozzle that drops the ink, and a drive mechanism that reciprocates the nozzle along the slot-type coating head. In this case, where the nozzle that drops the ink is reciprocated along the slot-type coating head, ink can be efficiently supplied to the entirety of the strip-shaped sheet in the width direction and the inside of the ink storage part can be filled with ink in a shorter time.

Preferably, the travel module includes one or more back-up rolls that are configured to press the strip-shaped sheet against the slot-type coating head. In this case, where the strip-shaped sheet is pressed against the slot-type coating head by using one or more back-up rolls, the uniformity of the thickness of the coating film can be improved by using a simple configuration and at low cost.

Preferably, the ink is solid dispersion type ink. Because the coating device coats the upper surface of the strip-shaped sheet with ink, even if solid dispersion type ink is used, solid particles in the ink are not likely to become densely distributed in a part of the coating film near the front surface of the coating film. Accordingly, for example, when a printed circuit board is produced by using ink including metal particles, high conductivity of a conductor layer can be easily obtained.

A method of producing a coated sheet according to another aspect of the present invention includes a step of coating a surface of a strip-shaped sheet with ink by using the coating device described above.

Because the method of producing a coated sheet uses the coating device described above, ink stored in the space adheres to the surface of the strip-shaped sheet, and the thickness of a coating film is adjusted by a downstream part of the slot-type coating head. Therefore, even when the ink has a comparatively low viscosity, the surface of the strip-shaped sheet can be uniformly coated with the ink easily. In the method of producing a coated sheet, ink is not stored in an open space but stored in the ink storage part that is hermetically sealed. Therefore, contact between ink and air is not likely to occur, and thus aging of ink is not likely to occur and degradation of the quality of ink can be suppressed.

### Details of Embodiments of the Present Invention

Hereinafter, a coating device and a method of producing a coated sheet according to the present invention will be described with reference to the drawings.

### First Embodiment

### [Coating Device]

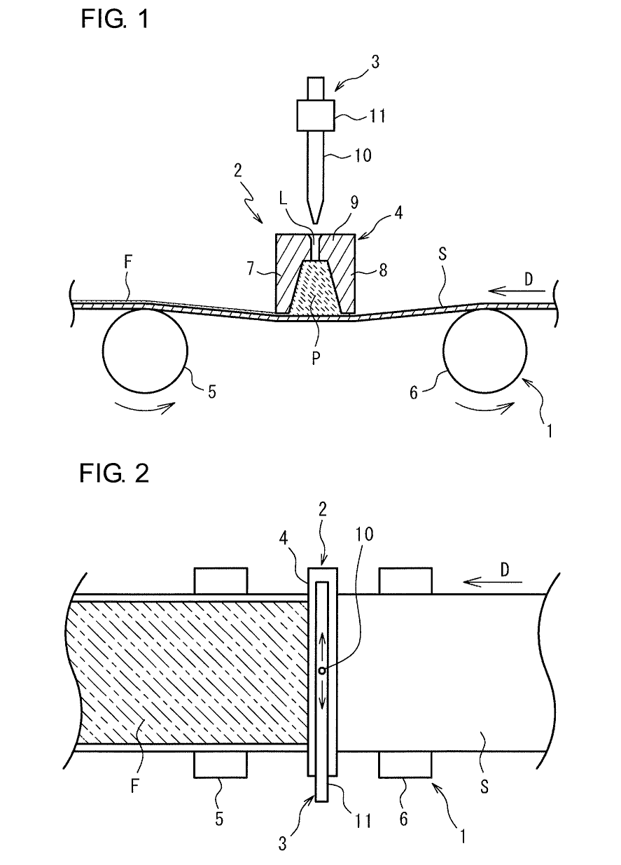

A coating device of FIGS. 1 and 2 mainly includes a module (travel module 1) that causes a strip-shaped sheet S to travel in a longitudinal direction, a module (coating module 2) that coats a surface of the strip-shaped sheet S with ink while the strip-shaped sheet S travels, and a module (supply module 3) that supplies the ink to the coating module 2. The coating device is used to form a coating film F of ink on the surface of the strip-shaped sheet S.

The coating module 2 includes a slot-type coating head 4 that is disposed above the strip-shaped sheet S so as to span the strip-shaped sheet S in the width direction. The slot-type coating head 4 includes an ink storage part P that widens toward the strip-shaped sheet S in cross-sectional view and an ink supply path L that communicates with an upper part of the ink storage part P.

### <Travel Module>

The travel module 1 causes the strip-shaped sheet S to travel in the longitudinal direction, preferably, horizontally. In FIGS. 1 and 2, the travel module 1 includes a mechanism that causes the strip-shaped sheet S to travel from right to left in a horizontal direction as indicated by a travel direction D. The term “horizontal” means having an angle relative to the vertical direction (the direction of gravity) in the range of 70° to 110°, preferably 80° to 100°, and more preferably 85° to 95°.

Examples of a mechanism that causes the strip-shaped sheet S to travel include a structure that rolls up the strip-shaped sheet S on the downstream side in the travel direction D. To be specific, the strip-shaped sheet S, which is rolled, is unrolled from an unroll unit on the upstream side in the travel direction D; the unrolled strip-shaped sheet S is coated with ink by the coating device and dried; and then, a leading end portion of the strip-shaped sheet S is rolled up in a roll-up unit on the downstream side in the travel direction D. The strip-shaped sheet S travels while tension is applied thereto by adjusting the power of motors that drive the unroll unit and the roll-up unit.

As illustrated in FIGS. 1 and 2, in the travel module 1, the slot-type coating head 4 is disposed on the upper surface side of the strip-shaped sheet S. The travel module 1 includes a first back-up roll 5, which contacts a lower surface of the strip-shaped sheet S on the downstream side of the slot-type coating head 4 in the travel direction D of the strip-shaped sheet S, and a second back-up roll 6, which contacts the lower surface of the strip-shaped sheet S on the upstream side of the slot-type coating head 4 in the travel direction D of the strip-shaped sheet S.

The first back-up roll 5 and the second back-up roll 6 are rotatably disposed and rotate in accordance with travelling of the strip-shaped sheet S. The first back-up roll 5 and the second back-up roll 6 may be rotationally driven so that the peripheral surfaces thereof move in a direction that is the same as the travel direction D of the strip-shaped sheet S.

The first back-up roll 5 and the second back-up roll 6 are disposed in directions such that the central axes thereof are parallel to each other and perpendicular to the travel direction D of the strip-shaped sheet S. The first back-up roll 5 and the second back-up roll 6 are disposed in such a way that a reference plane, which is a plane that includes two contact points where the peripheral surfaces of the rolls 5 and 6 contact the strip-shaped sheet S and which is parallel to the central axis, intersects a lower part of the slot-type coating head 4, that is, in such a way that the reference plane is located higher than the lower end of the slot-type coating head 4.

With this configuration, the strip-shaped sheet S is pressed against the slot-type coating head 4 due to the tension of the strip-shaped sheet S, which is spanned between the peripheral surfaces of the first back-up roll 5 and the second back-up roll 6. That is, the first back-up roll 5 and the second back-up roll 6 of the travel module 1 are configured to press the strip-shaped sheet S against the slot-type coating head 4 of the coating module 2. By pressing the strip-shaped sheet S against the slot-type coating head 4 by using the first back-up roll 5 and the second back-up roll 6 in this way, the uniformity of the thickness of the coating film F can be improved by using comparatively low-cost equipment.

Here, the pressure with which the travel module 1 presses the strip-shaped sheet S against the coating module 2 can be controlled by adjusting tension applied to the strip-shaped sheet S on the upstream side in the travel direction D, the linear velocity of the strip-shaped sheet S, the vertical positions of the first back-up roll 5 and the second back-up roll 6, and the like. Note that it is only necessary to press the strip-shaped sheet S against the coating module 2 by the tension of the strip-shaped sheet S that is spanned between the first back-up roll 5 and the second back-up roll 6. Therefore, the slot-type coating head 4 may be configured to be movable downward so that the lower end thereof becomes lower than the reference plane.

The lower limit of the linear velocity with which the travel module 1 causes the strip-shaped sheet S to travel is preferably 0.1 m/min, and more preferably 0.2 m/min. On the other hand, the upper limit of the linear velocity is preferably 3 m/min, and more preferably 2 m/min. If the linear velocity is less than the lower limit, the efficiency of producing a coated sheet may decrease. In contrast, if the linear velocity is greater than the upper limit, it may be difficult for the ink to adhere to the surface of the strip-shaped sheet S, and the thickness of the coating film F may become nonuniform.

### (Strip-Shaped Sheet)

As the strip-shaped sheet S, for example, a flexible resin, such as polyimide, a liquid crystal polymer, a fluorine resin, polyethylene terephthalate, polyethylene naphthalate, or the like can be used.

The width of the strip-shaped sheet S in a direction perpendicular to the longitudinal direction is determined in accordance with the width of a coated sheet to be formed and is not particularly limited. However, for example, the lower limit of the average width of the strip-shaped sheet S is preferably 10 mm, and more preferably 20 mm. On the other hand, for example, the upper limit of the average width of the strip-shaped sheet S is preferably 2 m, and more preferably 1.5 m. If the average width of the strip-shaped sheet S is less than the lower limit, it may be difficult to perform control to cause the strip-shaped sheet S to travel so that the thickness of the coating film F becomes uniform in the width direction. In contrast, if the average width of the strip-shaped sheet S is greater than the upper limit, it is difficult to fill the ink storage part P with ink uniformly in the width direction (as described below), and, as a result, it may be difficult to uniformly coat the surface of the strip-shaped sheet S with ink. <Coating Module>

As described above, the coating module 2 includes the slot-type coating head 4, which includes the ink storage part P and the ink supply path L and which is disposed so as to be pressed against the surface of the strip-shaped sheet S.

### (Slot-Type Coating Head)

In the slot-type coating head 4, the ink storage part P is defined by a back wall 7 on the downstream side in the travel direction D, a front wall 8 on the upstream side in the travel direction D, and an upper wall 9 that connects upper ends of the back wall 7 and the front wall 8 to each other. The ink storage part P has a groove-like shape that has a substantially trapezoidal cross section that widens downward toward the strip-shaped sheet S. The ink supply path L may be formed by a slit that is continuously formed in the upper wall 9 or through-holes that are discontinuously formed in the upper wall 9 so as to extend downward from the upper surface of the slot-type coating head 4 to communicate with the ink storage part P.

The material of the slot-type coating head 4 is preferably a metal, in view of strength and precision. Examples of such a metal include aluminum, steel, and stainless steel. Among these, stainless steel, which has high rust resistance, is preferable.

As illustrated in FIG. 2, preferably, the slot-type coating head 4 is disposed in such a way that the span direction is substantially perpendicular to the travel direction D of the strip-shaped sheet S. To be specific, in plan view, the lower limit of the angle between the span direction of the slot-type coating head 4 and the travel direction D is preferably 80°, and more preferably 85°. On the other hand, the upper limit of the angle is preferably 100°, and more preferably 95°. If the angle is outside this range, ink supplied to one side in the width direction of the strip-shaped sheet S and ink supplied to the other side in the width direction spread with different degrees, and it may become difficult to control the coating width of ink.

The ink storage part P is an internal space of a groove that is defined in the slot-type coating head 4 as described above. The lower end of the ink storage part P is sealed by the strip-shaped sheet S with a level of hermeticity such that ink can be stored inside the ink storage part P.

The lower limit of the average length of the lower end of the ink storage part P in the travel direction D, that is, the lower limit of the average length of a part where ink stored in the ink storage part P contacts the strip-shaped sheet S in the travel direction D is preferably 3 mm, and more preferably 5 mm. On the other hand, the upper limit of the average length of the lower end of the ink storage part P is preferably 30 mm, and more preferably 20 mm. If the average length of the lower end of the ink storage part P is less than the lower limit, the surface of the strip-shaped sheet S contacts ink in the ink storage part P only for a short time when the strip-shaped sheet S travels, and it may be difficult to make the thickness of the coating film F uniform. In contrast, if the average length of the lower end of the ink storage part P is greater than the upper limit, the amount of ink that needs to be supplied in order to form the coating film F having a uniform thickness may increase.

The lower limit of the average height of the ink storage part P (the average value, in the width direction, of the maximum vertical distance from strip-shaped sheet S in cross section) is preferably 2 mm, and more preferably 3 mm. On the other hand, the upper limit of the average height of the ink storage part P is preferably 10 mm, and more preferably 8 mm. If the average height of the ink storage part P is less than the lower limit, the volume of ink that can be stored in the ink storage part P is too small, and therefore it may not be possible to increase the linear velocity of the strip-shaped sheet S and the efficiency of producing a coated sheet may decrease. In contrast, if the average height of the ink storage part P is greater than the upper limit, it is difficult to fill an upper region of the ink storage part P with ink, and the effect of preventing degradation of ink may decrease.

Preferably, the lower limit of the average cross-sectional area of the ink storage part P is 2 mm², and more preferably 5 mm². On the other hand, the upper limit of the average cross-sectional area of the ink storage part P is 100 mm², and more preferably 50 mm². If the average cross-sectional area of the ink storage part P is less than the lower limit, the volume of ink that can be stored in the ink storage part P is too small, and therefore it may not be possible to increase the linear velocity of the strip-shaped sheet S and the efficiency of producing a coated sheet may decrease. In contrast, if the average cross-sectional area of the ink storage part P is greater than the upper limit, it takes a long time to fill the inside of the ink storage part P with ink, and the ink may be easily exposed to air in the ink storage part P.

As described above, the ink supply path L is a path through which ink, which is supplied by the supply module 3 from above, flows into the ink storage part P.

The lower limit of the average length of the ink supply path L in the travel direction D is preferably 0.02 mm, and more preferably 0.05 mm. On the other hand, the upper limit of the average length of the ink supply path L in the travel direction D is preferably 1.2 mm, and more preferably 1 mm. If the average length of the ink supply path L in the travel direction D is less than the lower limit, it may be difficult for ink to pass through the ink supply path L. In contrast, if the average length of the ink supply path L in the travel direction D is greater than the upper limit, air flows into and out of the ink storage part P and may degrade the quality of ink more easily.

The lower limit of the total length of the ink supply path L in the span direction of the slot-type coating head 4 is preferably 1/20 of the coating width of ink, and more preferably 1/10 of the coating width of ink. The upper limit of the length of the ink supply path L in the span direction of the slot-type coating head 4 is preferably the coating width of ink. If the total length of the ink supply path L in the span direction of the slot-type coating head 4 is less than the lower limit, it may not be possible to supply ink rapidly to the entirety of the ink storage part P. In contrast, if the total length of the ink supply path L in the span direction of the slot-type coating head 4 is greater than the upper limit, ink may contact air unnecessarily and the quality of ink may be degraded more easily.

### <Supply Module>

The supply module 3 includes one nozzle 10 that drops ink and a reciprocating mechanism 11 that reciprocates the nozzle 10 along the slot-type coating head 4.

The nozzle 10 is disposed above the slot-type coating head 4 so that ink can be dropped into the ink supply path L. As illustrated in FIG. 2, the nozzle 10 is reciprocated by the reciprocating mechanism 11 in the width direction with the center of the strip-shaped sheet S in the width direction as a central point.

The reciprocating mechanism 11 may be any mechanism that can reciprocate the nozzle 10. For example, the reciprocating mechanism 11 can be realized by using a mechanism that transmits power of a motor to the nozzle 10 via a belt or a gear.

Ink dropped into the ink supply path L flows into the ink storage part P. As ink is repeatedly dropped from the nozzle 10 into the ink supply path L, the inside of the ink storage part P becomes filled with ink.

Because the supply module 3 includes the reciprocating mechanism 11, the amount of ink stored in the ink storage part P can be easily made uniform in the width direction. As a result, the surface of the strip-shaped sheet S can be uniformly coated with ink easily. It may be possible to fill the inside of the ink storage part P with ink even if the supply module 3 does not have the reciprocating mechanism 11. In this case, however, it takes a long time until ink spreads to the farthest part of the ink storage part P in the width direction. With the coating device, although the surface of the strip-shaped sheet S is coated with ink while ink is being supplied from the supply module 3, it is possible to perform coating with a uniform thickness after ink in the ink storage part P has spread in the width direction. Accordingly, because the supply module 3 includes the reciprocating mechanism 11, it is possible to reduce time needed by ink to spread to the farthest part of the ink storage part P in the width direction. Accordingly, it is possible to reduce the amount of time from the time when dropping of ink from the nozzle 10 is started to the time when the surface of the strip-shaped sheet S can be uniformly coated with ink. Preferably, the nozzle 10 reciprocates in a range within equal distances in the width direction from the central position of the coating width of ink. In this case, it is possible to reduce time needed by ink to spread ink to both end portions of the ink storage part P in the width direction.

The lower limit of the amount of ink ejected by the nozzle 10 is preferably 0.1 mL/min, and more preferably 0.2 mL/min. On the other hand, the upper limit of the amount of ejected ink is preferably 1.0 mL/min, and more preferably 0.8 mL/min. If the amount of ejected ink is less than the lower limit, it may not be possible to increase the linear velocity of the strip-shaped sheet S, and the efficiency of producing the coated sheet may decrease. In contrast, if the amount of ejected ink is greater than the upper limit, the amount of ink stored in the ink storage part P becomes too large and ink in the ink storage part P applies a pressure to the surface of the strip-shaped sheet S, and it may be difficult to uniformly coat the surface with ink.

The lower limit of the movement speed of the nozzle 10, which reciprocates along the slot-type coating head 4, is preferably 2 mm/sec, and more preferably 5 mm/sec. On the other hand, the upper limit of the movement speed is preferably 50 mm/sec, and more preferably 30 mm/sec. If the movement speed is less than the lower limit, the amount of ink stored in a part of the ink storage part P in the width direction tends to become insufficient relative to the amount of ink with which the surface of the strip-shaped sheet S is to be coated, and it may be difficult to uniformly coat the surface with ink. In contrast, if the movement speed is greater than the upper limit, it may be difficult to control the position where ink is to be dropped into the ink supply path L, it may be difficult to store ink uniformly in the ink storage part P and to uniformly coat the surface with the ink.

The lower limit of the movement distance of the nozzle 10, which reciprocates along the slot-type coating head 4, is preferably 50% of the coating width of ink, and more preferably 70% of the coating width of ink. On the other hand, the upper limit of the movement distance is preferably 100% of the coating width of ink. If the movement distance is less than the lower limit, the amount of ink stored in an end portion of the ink storage part P in the width direction tends to become insufficient relative to the amount of ink with which the surface of the strip-shaped sheet S is to be coated, and it may be difficult to uniformly coat the surface with ink. In contrast, if the movement distance is greater than the upper limit, it may be necessary for the slot-type coating head 4 to have a complex structure in order to prevent ink from overflowing from the coating region.

The coating device, which is configured to drop ink by using the nozzle 10 as described above, can drop ink, which is hermetically stored, directly into the slot-type coating head 4 and can reduce time for which ink is exposed to air. Thus, the coating device can make the quality of ink less likely to degrade.

### (Ink)

As ink used by the coating device, ink having a comparatively low viscosity, which is used by a gravure-type coater or a bar-type coater, can be used. Solid dispersion type ink, in which solid particles are dispersed in liquid, can be also used.

The viscosity of ink used by the coating device is not particularly limited. For example, the viscosity may be in the range of 1.0 mPa·s to 1.8 mPa·s at 25° C.

Even when solid dispersion type ink is used, the coating device, which coats the upper surface of the strip-shaped sheet S with ink, does not cause a problem in that solid particles are densely distributed in a part of the coating film F away from the strip-shaped sheet S and the coating film F is peeled off. Examples of solid particles dispersed in the solid dispersion type ink include a coloring agent, such as an inorganic pigment or an organic pigment, and filler particles, such as inorganic fine particles or organic fine particles.

The coating device can use solid dispersion type ink in which metal particles, which are conducting substances, are dispersed as the inorganic fine particles. By performing coating with the solid dispersion type ink by using the coating device, it is possible to form a conductor layer of metal particles and to produce a substrate for a printed circuit board.

As a metal that forms metal particles included in the solid dispersion type ink, for example, copper (Cu), nickel (Ni), aluminum (Al), gold (Au), silver (Ag), or the like can be used. Among these, preferably, copper is used as a metal that has high conductivity and high adhesiveness to a flexible resin such as polyimide.

The lower limit of the average particle size of metal particles included in the solid dispersion type is preferably 1 nm, and more preferably 30 nm. The upper limit of the average particle size of the metal particles is preferably 500 nm, and more preferably 100 nm. If the average particle size of the metal particles is less than the lower limit, dispersibility and stability of the metal particles in the solid dispersion type ink may decrease. If the average particle size of the metal particles is greater than the upper limit, the metal particles may settle easily, and the density of metal particles does not easily become uniform when coating with the solid dispersion type ink is performed.

The lower limit of the average thickness of the coating film F formed by the solid dispersion type ink including the metal particles is preferably 0.05 μm, and more preferably 0.1 μm. The upper limit of the average thickness of the coating film F is preferably 10 μm, and more preferably 8 μm. If the average thickness of the coating film F is less than the lower limit, portions where the metal particles are not present in the thickness direction increase and the conductivity may decrease. On the other hand, if the average thickness of the coating film F is greater than the upper limit, it may be difficult to reduce the thickness of the conductor layer.

As the solid dispersion type ink including the metal particles, ink that includes a dispersant, for dispersing the metal particles, and a dispersion medium can be used. A method of adjusting the solid dispersion type ink will be described. As a dispersant included in the solid dispersion type ink, it is possible to use any dispersant that has a molecular weight in the range of 2,000 to 300,000 and that can appropriately disperse metal particles precipitated in a dispersion medium. By using a dispersant having a molecular weight in this range, it is possible to appropriately disperse the metal particles in the dispersion medium and to form a dense and defect-free conductor layer. If the molecular weight of the dispersant is less than the lower limit, it may not be possible to sufficiently obtain the effect of preventing aggregation of the metal particles to maintain dispersion. As a result, it may not possible to form a dense and defect-free conductor layer by performing coating with the solid dispersion type ink including the metal particles. On the other hand, if the molecular weight of the dispersant is greater than the upper limit, the dispersant is excessively bulky, and, in heat treatment performed after coating with the solid dispersion type ink has been performed, sintering of the metal particles may be inhibited and voids may be formed. If the dispersant is excessively bulky, the denseness of a conductor layer may decrease, and decomposition residues of the dispersant may decrease the conductivity.

Preferably, the dispersant does not contain sulfur, phosphorus, boron, a halogen, or an alkali, in view of prevention of degradation of components. Preferred examples of the dispersant, each having a molecular weight in the aforementioned range, include amine-based polymer dispersants, such as polyethyleneimine and polyvinylpyrrolidone; hydrocarbon-based polymer dispersants each having a carboxylic acid group in the molecule thereof, such as polyacrylic acid and carboxymethyl cellulose; and polymer dispersants each having a polar group, such as poval (polyvinyl alcohol), styrene-maleic acid copolymers, olefin-maleic acid copolymers, and copolymers having a polyethylenimine portion and a polyethylene oxide portion in one molecule.

The dispersant may be added to the reaction system in the form of a solution in which the dispersant is dissolved in water or a water-soluble organic solvent. The content of the dispersant is preferably 1 part by mass or more and 60 parts by mass or less per 100 parts by mass of the metal particles. The dispersant surrounds the metal particles to prevent aggregation of the metal particles, thereby appropriately dispersing the metal particles. If the content of the dispersant is less than the lower limit, the effect of preventing the aggregation may be insufficient. On the other hand, if the content of the dispersant is greater than the upper limit, during heat treatment performed after coating with the solid dispersion type ink has been performed, an excessive amount of the dispersant may inhibit firing, including sintering of the metal particles, and voids may be formed, and decomposition residues of the polymer dispersant may remain as impurities in the conductor layer and may decrease the conductivity.

The content of water, which serves as the dispersion medium, in the solid dispersion type ink is preferably 20 parts by mass or more and 1900 parts by mass or less per 100 parts by mass of the metal particles. Water serving as the dispersion medium sufficiently swells the dispersant to appropriately disperse the metal particles surrounded by the dispersant. If the content of water is less than the lower limit, the swelling effect of the dispersant due to water may be insufficient. On the other hand, if the content of water is greater than the upper limit, the proportion of the metal particles in the solid dispersion type ink is small, and it may not be possible to form an appropriate conductor layer, having a necessary thickness and a necessary density, on the surface of the strip-shaped sheet S.

Various water-soluble organic solvents can be used as an organic solvent that is optionally mixed with the solid dispersion type ink. Specific examples of the organic solvent include alcohols such as methyl alcohol, ethyl alcohol, n-propyl alcohol, isopropyl alcohol, n-butyl alcohol, isobutyl alcohol, sec-butyl alcohol, and tert-butyl alcohol; ketones such as acetone and methyl ethyl ketone; esters of a polyhydric alcohol, such as ethylene glycol or glycerin, or other esters; and glycol ethers such as ethylene glycol monoethyl ether and diethylene glycol monobutyl ether.

The content of the water-soluble organic solvent is preferably 30 parts by mass or more and 900 parts by mass or less per 100 parts by mass of the metal particles. If the content of the water-soluble organic solvent is less than the lower limit, it may not be possible to obtain the effect of the organic solvent in adjusting the viscosity and the vapor pressure of the dispersion. On the other hand, if the content of the water-soluble organic solvent is greater than the upper limit, the swelling effect of the dispersant due to water may become insufficient and aggregation of the metal particles may occur in the solid dispersion type ink.

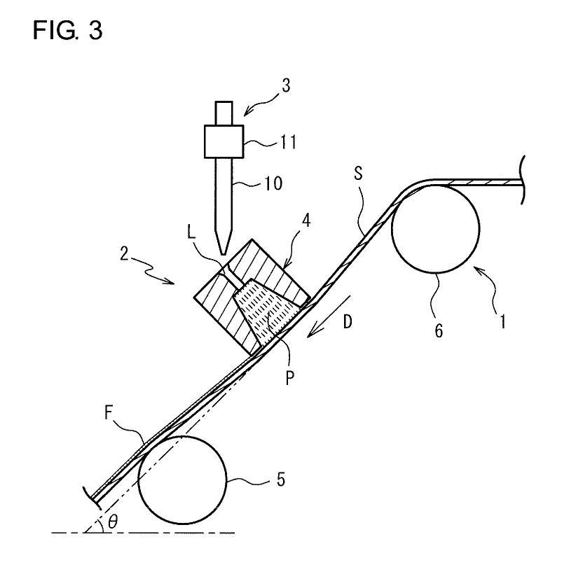

As illustrated in FIG. 3, in the coating device, the strip-shaped sheet S may travel so as to be inclined at a position where the strip-shaped sheet S passes the coating module 2. At the position where the strip-shaped sheet S passes the coating module 2, the lower limit of the inclination θ of the travel direction D of the strip-shaped sheet S relative to the horizontal direction is preferably −90°, and more preferably −80°. On the other hand, the upper limit of the inclination θ is preferably 90°, and more preferably 80°. If the inclination θ is less than the lower limit or greater than the upper limit, it is difficult for ink stored in the ink storage part P to contact the surface of the strip-shaped sheet S, and it may be difficult to uniformly coat the surface of the strip-shaped sheet S in the width direction. In this case, when the solid dispersion type ink is used, solid particles become densely distributed in a part of the coating film F near the front surface of the coating film F, and the coating film F may be easily peeled off. In FIG. 3, a dash-dot line represents a horizontal plane, and the inclination θ when the travel direction D is inclined downward as shown in the figure is defined as a positive angle relative to the horizontal plane.

### [Method of Producing Coated Sheet]

A method of producing a coated sheet uses the coating device of FIG. 1 and includes a step (supply step) of supplying ink to the ink supply path L of the slot-type coating head 4, and a step (coating step) of coating a surface of the strip-shaped sheet S with ink.

### (Supply Step)

In the supply step, the ink storage part P of the slot-type coating head 4 is filled with ink by dropping ink from the nozzle 10 at predetermined time intervals while reciprocating the nozzle 10 along the slot-type coating head 4 by using the reciprocating mechanism 11.

### (Coating Step)

In the coating step, the surface of the strip-shaped sheet S is coated with ink by causing the strip-shaped sheet S to travel while pressing the strip-shaped sheet S against the slot-type coating head 4. To be specific, the strip-shaped sheet S is pressed against the slot-type coating head 4 by using the tension of the strip-shaped sheet S that is spanned between the first back-up roll 5 and the second back-up roll 6 and that travels. Thus, ink stored in the ink storage part P contacts the surface of the strip-shaped sheet S, and thereby the ink adheres to the surface of the strip-shaped sheet S; and, as the strip-shaped sheet S travels, ink is drawn out of the ink storage part P in accordance with travelling of the strip-shaped sheet S. At this time, the back wall 7 of the slot-type coating head 4 functions as a doctor that restricts the thickness of the layer of ink drawn out in accordance with travelling of the strip-shaped sheet S, and a coated sheet in which a coating film F having a uniform thickness is formed on the surface of the strip-shaped sheet S is obtained.

The thickness of the coating film F, which depends on the viscosity of ink and the slot-type coating head 4, can be adjusted by controlling the press-contact force with which the strip-shaped sheet S is pressed against the slot-type coating head 4 and the travelling speed of the strip-shaped sheet S.

After the coating step, the coating film F of the coated sheet is dried by, for example, blowing hot air, and thereby the coated sheet is obtained. The coated sheet is rolled up, for example, by the roll-up unit.

When coating with the solid dispersion type ink is performed, after the drying, a heat treatment is further performed. Due to the heat treatment, the metal particles are sintered to form a sintered compact, and the sintered compact adheres to the strip-shaped sheet S to form a conductor layer. The dispersant and other organic materials contained in the solid dispersion type ink are evaporated or decomposed due to the heat treatment.

### [Advantages]

In the coating device, the slot-type coating head 4 includes the ink storage part P. Therefore, the coating device does not adjust the thickness of the coating film F by controlling the amount of ink supplied to the slot-type coating head 4. Instead, the coating device can adjust the thickness of a layer of ink that is drawn out in accordance with travelling of the surface of the strip-shaped sheet S by using the back wall 7, which forms a side wall of the ink storage part P of the slot-type coating head 4 on the downstream side in the travel direction D of the strip-shaped sheet S, as a doctor for adjusting the thickness of the layer of ink. Therefore, the coating device can perform coating with ink having a comparatively low viscosity. Moreover, the coating device can suppress degradation of the quality of ink, because the coating device can reduce contact between ink and air by supplying ink into the ink storage part P that is closed. Therefore, the method of producing a coated sheet using the coating device can be used to produce a high quality coated sheet by suppressing degradation of ink.

### Second Embodiment

### Coating Device

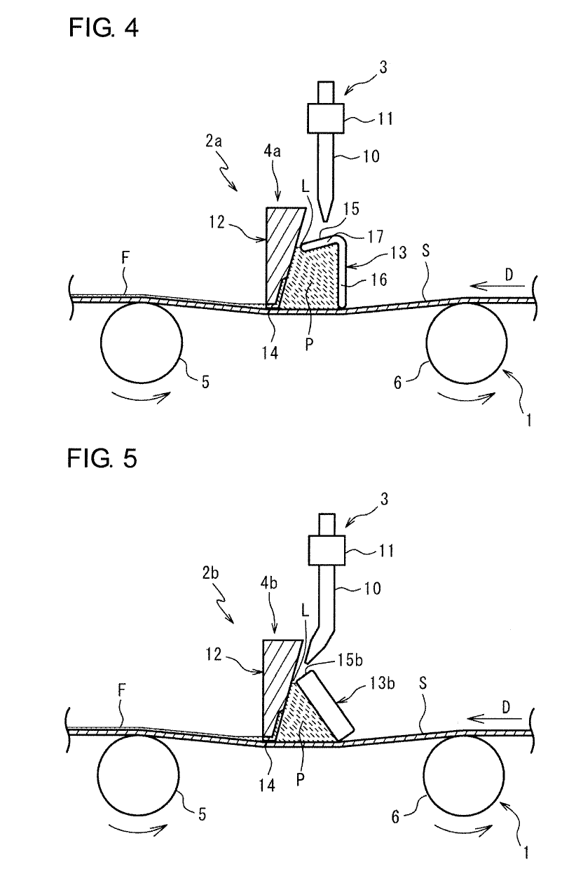

A coating device of FIG. 4 mainly includes a module (travel module 1) that causes a strip-shaped sheet S to travel in a longitudinal direction, a module (coating module 2a) that coats a surface of the strip-shaped sheet S with ink while the strip-shaped sheet S travels, and a module (supply module 3) that supplies the ink to the coating module 2a.

The coating module 2a includes a slot-type coating head 4a that is disposed above the strip-shaped sheet S so as to span the strip-shaped sheet S in the width direction. The slot-type coating head 4a includes an ink storage part P that widens toward the strip-shaped sheet S in cross-sectional view and a slit-shaped ink supply path L that communicates with an upper part of the ink storage part P.

The travel module 1 and the supply module 3 of the coating device of FIG. 4 are the same as the travel module 1 and the supply module 3 of the coating device of FIG. 1. The ink used for coating and the strip-shaped sheet S to be coated with the ink by the coating device of FIG. 4 are the same as the ink used for coating and the strip-shaped sheet S to be coated with the ink by the coating device of FIG. 1.

### <Coating Module>

As described above, the coating module 2a includes the slot-type coating head 4a, which includes the ink storage part P and the ink supply path L and which is disposed so as to be pressed against the surface of the strip-shaped sheet S.

### (Slot-Type Coating Head)

The slot-type coating head 4a includes a pair of bar-shaped members (a doctor member 12 and an auxiliary member 13) that are disposed parallel to each other and in such a way that upper parts thereof are adjacent to each other, and a gap between the pair of bar-shaped members forms an ink storage part P and an ink supply path L. That is, in the slot-type coating head 4a according to the present embodiment, the bar-shaped doctor member 12 and the bar-shaped auxiliary member 13 are disposed parallel to the width direction of the strip-shaped sheet S, and a gap between upper parts, which are adjacent to each other, of these members 12 and 13 forms the ink supply path L; and a space that is located below the ink supply path L and that widens toward the strip-shaped sheet S forms the ink storage part P. By forming the storage part P and the ink supply path L by using a pair of bar-shaped members in this way, design and formation of the slot-type coating head 4a are facilitated. The term “bar-shaped portion” means a shape that is elongated in one direction, in particular, a shape whose dimension in the longitudinal direction is five times or more of the dimension in a direction perpendicular to the longitudinal direction. The cross-sectional shape of the “bar-shaped portion” is not particularly limited.

The dimensions and the like of the ink storage part P and the ink supply path L of the slot-type coating head 4a of the coating device of FIG. 4 are the same as those of the ink storage part P and the ink supply path L of the slot-type coating head 4 of the coating device of FIG. 1.

The cross-sectional shape of the doctor member 12 is a trapezoidal shape that is elongated in the vertical direction, and the width of the lower end surface is smaller than that of the upper end surface. The lower end surface of the doctor member 12 faces the strip-shaped sheet S.

The material of the doctor member 12 is preferably a metal, in view of strength and precision. Examples of such a metal include aluminum, steel, and stainless steel. Among these, stainless steel, which has high rust resistance, is preferable.

The doctor member 12 has a plurality of grooves 14, which are parallel to the travel direction D of the strip-shaped sheet S, in a lower part thereof. The plurality of grooves 14 reduce travelling resistance applied to the strip-shaped sheet S by the slot-type coating head 4a, and thereby stabilizes the travel condition of the strip-shaped sheet S and further the thickness of the coating film F formed on the strip-shaped sheet S. By adjusting the size and the number of the plurality of grooves 14, it is possible to adjust the amount of ink drawn out of the ink storage part P in accordance with travelling of the strip-shaped sheet S, that is, the thickness of the film.

The grooves 14 may be formed at least in a region (lower end surface) of the doctor member 12 adjacent to the strip-shaped sheet S. Preferably, in order to stabilize the outflow of ink, the grooves 14 are formed so as to extend from the lower end surface of the doctor member 12 to at least a lower part of the inner wall surface of the ink storage part P.

The cross-sectional shape of each of the grooves 14 in a direction perpendicular to the extension direction of the grooves 14 may be, for example, semicircular, U-shaped, V-shaped, or corrugated. Among these, a curved corrugated shape is preferable, because, in this case, it is easy to make the thickness of the coating film F to be formed on the surface of the strip-shaped sheet S uniform.

The lower limit of the average depth of the grooves 14 formed in the doctor member 12 is preferably 3 μm, and more preferably 5 μm. On the other hand, the upper limit of the average depth of the grooves 14 is preferably 130 μm, and more preferably 100 μm. If the average depth of the grooves 14 is less than the lower limit, it may be difficult to form the grooves 14 having a uniform depth. In contrast, if the average depth of the grooves 14 is greater than the upper limit, it may not be possible to sufficiently obtain the effect of making the coating thickness of ink uniform.

The lower limit of the average pitch of the grooves 14 formed in the doctor member 12 is preferably 20 μm, and more preferably 50 μm. On the other hand, the upper limit of the average pitch of the grooves 14 is preferably 800 μm, and more preferably 500 μm. If the average pitch of the grooves 14 is less than the lower limit, it is difficult to form the grooves 14 so as to have a large thickness, and therefore it may not be possible to sufficiently obtain the effect of making the coating thickness of ink uniform. In contrast, if the average pitch of the grooves 14 is greater than the upper limit, the number of grooves in the width direction of the strip-shaped sheet S is reduced, and therefore it may not be possible to sufficiently obtain the effect of making the coating thickness of ink uniform.

The plurality of grooves 14 may be formed by joining another member, such as a plurality of wires, to the doctor member 12.

In the case of forming the grooves 14 by arranging and joining a plurality of wires side by side without a gap therebetween, the lower limit of the average diameter of the wires is preferably 0.02 mm, and more preferably 0.05 mm. On the other hand, the upper limit of the average diameter of the wires is preferably 1.2 mm, and more preferably 1 mm. If the average diameter of the wires is less than the lower limit, the pitch of the grooves formed in the doctor member 12 is too small, and it may not be possible to sufficiently obtain the effect of making the coating thickness of ink uniform. In contrast, if the average diameter of the wires is greater than the upper limit, the depth of grooves that are formed in the peripheral surface of the doctor member 12 in a stripe pattern is too large, and it may not be possible to sufficiently obtain the effect of making the coating thickness of ink uniform.

The auxiliary member 13, in cross-sectional shape, includes a plate-shaped side wall 16 that faces the doctor member 12 and an upper wall 17 that is bent from the upper end of the side wall 16 and extends toward the doctor member 12. That is, the auxiliary member 13 according to the present embodiment is a bar having an L-shaped cross section.

The auxiliary member 13 has an inclined surface 15, which is inclined at an angle of depression in a direction toward the doctor member 12, in an upper part thereof. That is, an upper surface of the upper wall 17 of the auxiliary member 13 is the inclined surface 15. The inclined surface 15 is inclined in such a way that the inclined surface 15 descends toward the doctor member 12, that is, a part of the inclined surface 15 near the ink supply path L, which is a gap between the inclined surface and the doctor member 12, becomes lower. Thus, the supply module 3 can supply ink into the ink supply path L along the inclined surface 15 and can fill the ink storage part P with the ink comparatively easily.

The material of the auxiliary member 13 is preferably a metal, in view of strength and precision. Examples of such a metal include aluminum, steel, and stainless steel. Among these, stainless steel, which has high rust resistance, is preferable.

The coating device of FIG. 4 can be used, as with the coating device of FIG. 1, in the method of producing a coated sheet according to an embodiment of the present invention.

### Third Embodiment

A coating device of FIG. 5 mainly includes a module (travel module 1) that causes a strip-shaped sheet S to travel in a longitudinal direction, a module (coating module 2b) that coats a surface of the strip-shaped sheet S with ink while the strip-shaped sheet S travels, and a module (supply module 3) that supplies the ink to the coating module 2b.

The coating module 2b includes a slot-type coating head 4b that is disposed above the strip-shaped sheet S so as to span the strip-shaped sheet S in the width direction. The slot-type coating head 4b includes an ink storage part P that widens toward the strip-shaped sheet in cross-sectional view and a slit-shaped ink supply path L that communicates with an upper part of the ink storage part P.

The travel module 1 of the coating device of FIG. 5 is the same as the travel module 1 of the coating device of FIG. 1. The supply module 3 of the coating device of FIG. 5 is the same as the supply module 3 of the coating device of FIG. 1 except that the nozzle 10 is bent so as to avoid interference with the coating module 2b. The ink used for coating and the strip-shaped sheet S to be coated with the ink by the coating device of FIG. 5 are the same as the ink used for coating and the strip-shaped sheet S to be coated with the ink by the coating device of FIG. 1.

### <Coating Module>

As described above, the coating module 2b includes the slot-type coating head 4b, which includes the ink storage part P and the ink supply path L and which is disposed so as to be pressed against the surface of the strip-shaped sheet S.

### (Slot-Type Coating Head)

The slot-type coating head 4b includes a pair of bar-shaped members (a doctor member 12 and an auxiliary member 13b) that are disposed parallel to each other and in such a way that upper parts thereof are adjacent to each other, and a gap between the pair of bar-shaped members forms an ink storage part P and an ink supply path L.

The dimensions and the like of the ink storage part P and the ink supply path L of the slot-type coating head 4b of the coating device of FIG. 5 are the same as those of the ink storage part P and the ink supply path L of the slot-type coating head 4 of the coating device of FIG. 1. The doctor member 12 of the coating device of FIG. 5 is the same as the doctor member 12 of the coating device of FIG. 4.

The auxiliary member 13b is a flat bar having a substantially rectangular cross-sectional shape. The auxiliary member 13b is inclined in such a way that an upper end thereof leans against the doctor member 12. The auxiliary member 13b forms an ink storage part P having a triangular shape in cross-sectional view, and has a gap that forms the ink supply path L between the auxiliary member 13b and the doctor member 12. An upper part of the auxiliary member 13b, that is, an upper end surface of the auxiliary member 13b is an inclined surface 15b that is inclined at an angle of depression in a direction toward the doctor member 12.

The auxiliary member 13b is inclined in such a way that the lower end surface thereof is separated from the strip-shaped sheet S on the upstream side in the travel direction D. Therefore, if ink supplied from the supply module 3 overflows from the inclined surface 15 toward the upstream side in the travel direction D, it is possible to transfer the overflowed ink to a space between the lower end surface of the auxiliary member 13b and the strip-shaped sheet S as the strip-shaped sheet S travels and to supply the overflowed ink to the ink storage part P through the gap between the auxiliary member 13b and the strip-shaped sheet S due to the wedge film effect.

The coating device of FIG. 5 can be used, as with the coating device of FIG. 1, in the method of producing a coated sheet according to an embodiment of the present invention.

### Fourth Embodiment

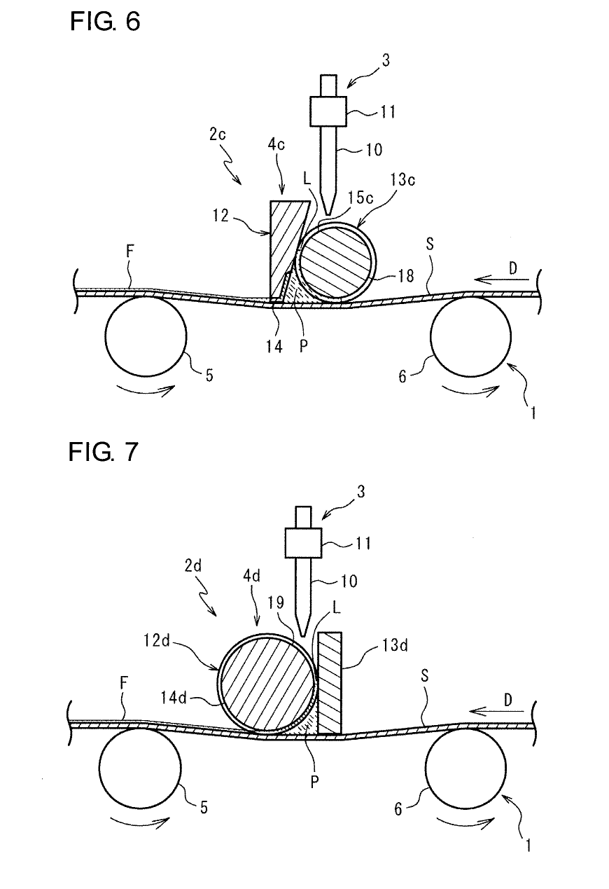

A coating device of FIG. 6 mainly includes a module (travel module 1) that causes a strip-shaped sheet S to travel in a longitudinal direction, a module (coating module 2c) that coats a surface of the strip-shaped sheet S with ink while the strip-shaped sheet S travels, and a module (supply module 3) that supplies the ink to the coating module 2c.

The coating module 2c includes a slot-type coating head 4c that is disposed above the strip-shaped sheet S so as to span the strip-shaped sheet S in the width direction. The slot-type coating head 4c includes an ink storage part P that widens toward the strip-shaped sheet S in cross-sectional view and a slit-shaped ink supply path L that communicates with an upper part of the ink storage part P.

The travel module 1 and the supply module 3 of the coating device of FIG. 6 are the same as the travel module 1 and the supply module 3 of the coating device of FIG. 1. The ink used for coating and the strip-shaped sheet S to be coated with the ink by the coating device of FIG. 6 are the same as the ink used for coating and the strip-shaped sheet S to be coated with the ink by the coating device of FIG. 1.

### <Coating Module>

As described above, the coating module 2c includes the slot-type coating head 4c, which includes the ink storage part P and the ink supply path L and which is disposed so as to be pressed against the surface of the strip-shaped sheet S.

### (Slot-Type Coating Head)

The slot-type coating head 4c includes a pair of bar-shaped members (a doctor member 12 and an auxiliary member 13c) that are disposed parallel to each other and in such a way that upper parts thereof are adjacent to each other, and a gap between the pair of bar-shaped members forms an ink storage part P and an ink supply path L.

The dimensions and the like of the ink storage part P and the ink supply path L of the slot-type coating head 4c of the coating device of FIG. 6 are the same as those of the ink storage part P and the ink supply path L of the slot-type coating head 4 of the coating device of FIG. 1. The doctor member 12 of the coating device of FIG. 6 is the same as the doctor member 12 of the coating device of FIG. 4.

The cross-sectional shape of the auxiliary member 13c is circular. A plurality of grooves 18, which are parallel to the travel direction D of the strip-shaped sheet S, are formed around the entire periphery thereof. The auxiliary member 13c is disposed in contact with the doctor member 12, and the grooves 18 form gaps that form the ink supply path L. A peripheral surface of the auxiliary member 13c above a contact portion where the auxiliary member 13c is in contact with the doctor member 12 is an inclined surface 15c that is inclined at an angle of depression in a direction toward the doctor member 12.

The auxiliary member 13c may be rotationally driven so that a part thereof facing the strip-shaped sheet S moves in a direction the same as the travel direction D of the strip-shaped sheet S. By rotationally driving the auxiliary member 13c in this way, the auxiliary member 13c suppresses outflow of ink through the grooves 18 toward the upstream side in the travel direction D and can cause ink that has overflowed toward the upstream side in the travel direction D to flow into the ink storage part P. Moreover, by rotating the auxiliary member 13c in this way, it is possible to stir ink in the ink storage part P and to maintain the uniformity of the ink. The auxiliary member 13c may be rotationally driven in accordance with travelling of the strip-shaped sheet S or may be rotated independently from travelling of the strip-shaped sheet S.

The material of at least a surface layer of the auxiliary member 13c is preferably a metal, in view of strength and precision. Examples of such a metal include aluminum, steel, and stainless steel. Among these metals, stainless steel, which has high rust resistance, is preferable.

The lower limit of the average diameter of the auxiliary member 13c is preferably 2 mm, and more preferably 4 mm. On the other hand, the upper limit of the average diameter of the auxiliary member 13c is preferably 50 mm, and more preferably 30 mm. If the average diameter of the auxiliary member 13c is less than the lower limit, the amount of ink that can be stored in the ink storage part P is small, and it may be difficult to uniformly coat the surface of the strip-shaped sheet S with ink. In contrast, if the average diameter of the auxiliary member 13c is greater than the upper limit, the ink storage part P is too large, therefore it may be difficult to fill the inside of the ink storage part P with ink, and the effect of preventing degradation of ink by hermetic sealing may decrease.

The grooves 18 of the auxiliary member 13c may be formed from a single groove that is helically formed in the peripheral surface of the auxiliary member 13c or may formed by arranging a plurality of grooves formed in the circumferential direction of the peripheral surface of the auxiliary member 13c. The single helical groove is also interpreted as the plurality of parallel grooves 18 in a lower part of the auxiliary member 13c.

The sectional shape, the dimensions, and the arrangement pitch of the grooves 18 of the auxiliary member 13c of the coating device of FIG. 6 may be the same as the sectional shape, the dimensions, and the arrangement pitch of the grooves 14 of the doctor member 12 of the coating device of FIG. 4.

The helical groove 18 may be formed by helically winding a wire around the peripheral surface of the auxiliary member 13c. The wire may be densely wound so that peripheral surfaces thereof closely contact each other or may be wound so that a gap is formed between peripheral surfaces of the wire. Between these, it is easier to form the stripe-shaped groove 18 uniformly by winding the wires so that the peripheral surfaces of the wires closely contact each other.

The coating device of FIG. 6 can be used, as with the coating device of FIG. 1, in the method of producing a coated sheet according to an embodiment of the present invention.

### Fifth Embodiment

A coating device of FIG. 7 mainly includes a module (travel module 1) that causes a strip-shaped sheet S to travel in a longitudinal direction, a module (coating module 2d) that coats a surface of the strip-shaped sheet S with ink while the strip-shaped sheet S travels, and a module (supply module 3) that supplies the ink to the coating module 2d.

The coating module 2d includes a slot-type coating head 4d that is disposed above the strip-shaped sheet S so as to span the strip-shaped sheet S in the width direction. The slot-type coating head 4d includes an ink storage part P that widens toward the strip-shaped sheet S in cross-sectional view and a slit-shaped ink supply path L that communicates with an upper part of the ink storage part P.

The travel module 1 and the supply module 3 of the coating device of FIG. 7 are the same as the travel module 1 and the supply module 3 of the coating device of FIG. 1. The ink used for coating and the strip-shaped sheet S to be coated with the ink by the coating device of FIG. 7 are the same as the ink used for coating and the strip-shaped sheet S to be coated with the ink by the coating device of FIG. 1.

### <Coating Module>

As described above, the coating module 2d includes the slot-type coating head 4d, which includes the ink storage part P and the ink supply path L and which is disposed so as to be pressed against the surface of the strip-shaped sheet S.

### (Slot-Type Coating Head)

The slot-type coating head 4d includes a pair of bar-shaped members (a doctor member 12d and an auxiliary member 13d) that are disposed parallel to each other and in such a way that upper parts thereof are adjacent to each other, and a gap between the pair of bar-shaped members forms an ink storage part P and an ink supply path L.

The dimensions and the like of the ink storage part P and the ink supply path L of the slot-type coating head 4d of the coating device of FIG. 7 are the same as those of the ink storage part P and the ink supply path L of the slot-type coating head 4 of the coating device of FIG. 1.

The cross-sectional shape of the doctor member 12d is circular. A plurality of grooves 14d are formed around the entire periphery thereof. The auxiliary member 13d is a flat bar having a cross-sectional shape that perpendicularly stands on the strip-shaped sheet S. The auxiliary member 13d is in contact with the doctor member 12d and forms an ink storage part P having a triangular shape in cross-sectional view. The plurality of grooves 14d of the doctor member 12d have gaps that form the ink supply path L between the doctor member 12d and the auxiliary member 13d. A peripheral surface of the doctor member 12d above a contact portion where the doctor member 12d is in contact with the auxiliary member 13d forms an inclined surface 19 that is inclined at an angle of depression in a direction toward the auxiliary member 13d.

The lower limit of the average diameter of the doctor member 12d is preferably 2 mm, and more preferably 4 mm. On the other hand, the upper limit of the average diameter of the doctor member 12d is preferably 50 mm, and more preferably 30 mm. If the average diameter of the doctor member 12d is less than the lower limit, the amount of ink that is stored in the ink storage part P is small, and it may be difficult to uniformly coat the surface of the strip-shaped sheet S with ink. In contrast, if the average diameter of the doctor member 12d is greater than the upper limit, the ink storage part P is too large, and therefore the inside of the ink storage part P may not be filled with ink and coating of the surface of the strip-shaped sheet S with ink may become nonuniform.

The shape and the dimensions of the grooves 14d of the doctor member 12d of the coating device of FIG. 7 are the same as the shape and the dimensions of the grooves 14 of the doctor member 12 of the coating device of FIG. 4.

The coating device of FIG. 7 can be used, as with the coating device of FIG. 1, in the method of producing a coated sheet according to an embodiment of the present invention.

### Sixth Embodiment

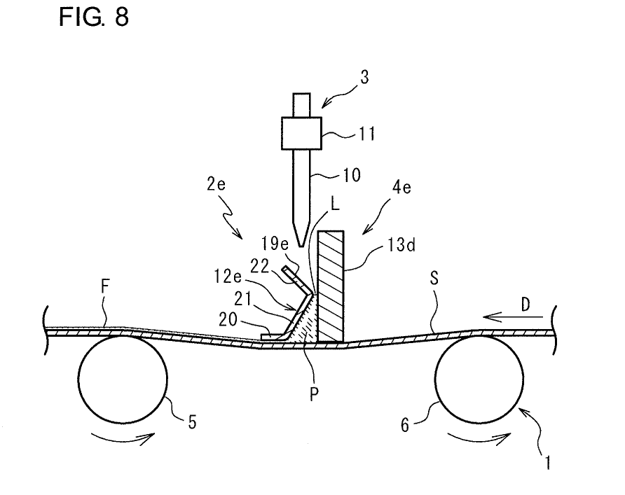

A coating device of FIG. 8 mainly includes a module (travel module 1) that causes a strip-shaped sheet S to travel in a longitudinal direction, a module (coating module 2e) that coats a surface of the strip-shaped sheet S with ink while the strip-shaped sheet S travels, and a module (supply module 3) that supplies the ink to the coating module 2e.

The coating module 2e includes a slot-type coating head 4e that is disposed above the strip-shaped sheet S so as to span the strip-shaped sheet S in the width direction. The slot-type coating head 4e includes an ink storage part P that widens toward the strip-shaped sheet S in cross-sectional view and a slit-shaped ink supply path L that communicates with an upper part of the ink storage part P.

The travel module 1 and the supply module 3 of the coating device of FIG. 8 are the same as the travel module 1 and the supply module 3 of the coating device of FIG. 1. The ink used for coating and the strip-shaped sheet S to be coated with the ink by the coating device of FIG. 8 are the same as the ink used for coating and the strip-shaped sheet S to be coated with the ink by the coating device of FIG. 1.

### <Coating Module>

As described above, the coating module 2e includes the slot-type coating head 4e, which includes the ink storage part P and the ink supply path L and which is disposed so as to be pressed against the surface of the strip-shaped sheet S.

### (Slot-Type Coating Head)

The slot-type coating head 4e includes a pair of bar-shaped members (a doctor member 12e and an auxiliary member 13d) that are disposed parallel to each other and in such a way that upper parts thereof are adjacent to each other, and a gap between the pair of bar-shaped members forms an ink storage part P and an ink supply path L.

The dimensions and the like of the ink storage part P and the ink supply path L of the slot-type coating head 4e of the coating device of FIG. 8 are the same as those of the ink storage part P and the ink supply path L of the slot-type coating head 4 of the coating device of FIG. 1. The auxiliary member 13d of the coating device of FIG. 8 is the same as the auxiliary member 13d of the coating device of FIG. 7.

The doctor member 12e includes a film-thickness adjusting portion 20 that is flat-plate-shaped and disposed parallel to the surface of the strip-shaped sheet S that travels; a sealing portion 21 that is flat-plate-shaped, that is connected to an upstream edge of the film-thickness adjusting portion 20 in the travel direction D, and that is inclined in such a way that the distance from the surface of the strip-shaped sheet S increases on the upstream side in the travel direction D; and an inclined portion 22 that is connected to an upstream edge of the sealing portion 21 in the travel direction D and inclined in such a way that the distance from the surface of the strip-shaped sheet S increases on the downstream side in the travel direction D.

The doctor member 12e is disposed in such a way that the upstream edge of the sealing portion 21 forms a gap that forms an ink supply path L between the upstream edge and a surface of the auxiliary member 13d on the downstream side in the travel direction D. Thus, an ink storage part P, which is sealed with a level of hermeticity such that ink can be stored by using the strip-shaped sheet S, is formed between the sealing portion 21 and the auxiliary member 13d. An upper surface of the inclined portion 22 is an inclined surface 19e that is inclined at an angle of depression in a direction toward the auxiliary member 13d.

The material of the doctor member 12e is preferably a metal, in view of strength and precision. Examples of such a metal include aluminum, steel, and stainless steel. Among these, stainless steel, which has high rust resistance, is preferable.

The film-thickness adjusting portion 20 and the inclined portion 22 of the doctor member 12e may be omitted. In this case, the lower edge of the sealing portion 21 adjusts the thickness of the coating film F so that the thickness becomes uniform.

The coating device of FIG. 8 can be used, as with the coating device of FIG. 1, in the method of producing a coated sheet according to an embodiment of the present invention.

### Other Embodiments

It should be understood that the embodiments disclosed herein are only examples and are not restrictive in all respects. The scope of the present invention is not limited to the configuration of the embodiments described above, is defined by the claims described below, and is intended to cover all the modifications within the meaning of the claims and the equivalents thereof.

For example, a plurality of grooves may be formed in a part of the slot-type coating head of the coating device according to the first embodiment, the part facing the strip-shaped sheet S. As appropriate, grooves may be formed or may not be formed in the doctor member and the auxiliary member according to other embodiments.

An auxiliary member having a circular cross section may be unrotatably disposed, or a doctor member having a circular cross section may be rotatably disposed.

The cross-sectional shape of the slot-type coating head may be a combination of any shape and any size, as long as an ink storage part can be formed. Any combination of the shapes of a doctor member and an auxiliary member may be used. For example, the equipment cost can be reduced by using a doctor member and an auxiliary member having the same shape. Examples of the cross-sectional shape of a doctor member or an auxiliary member that differ from that of the embodiments described above include a semicircular shape, an elliptical shape, a triangular shape, and a polygonal shape with chamfered corners.

In the embodiments described above, the strip-shaped sheet is pressed against the coating module by using the tension of the strip-shaped sheet that is spanned between the first back-up roll and the second back-up roll. However, the strip-shaped sheet may be pressed against the coating module by using one back-up roll or three or more back-up rolls. For example, in FIG. 1, by shifting the position from which the strip-shaped sheet S is fed out upward, the strip-shaped sheet S can be pressed against the coating module by using the tension between the feed-out part of the strip-shaped sheet S and the first back-up roll. In this case, the strip-shaped sheet S can be pressed by using one back-up roll.

The strip-shaped sheet may be pressed against the coating module by using a method that does not use the tension of the strip-shaped sheet spanned between back-up rolls. For example, in FIG. 4, back-up rolls may be disposed at positions that respectively face the auxiliary member and the doctor member with the strip-shaped sheet S therebetween, and these back-up rolls may press the auxiliary member and the doctor member.

The strip-shaped sheet may be pressed against the coating module without using a back-up roll. For example, the coating module may be disposed below a feed-out part of strip-shaped sheet on the upstream side and a draw-in part of the strip-shaped sheet on the downstream side, and the strip-shaped sheet may be pressed against the coating module by using the tension between the feed-out part and the draw-in part.

In the embodiments described above, the supply module reciprocates the nozzle along the slot-type coating head. However, the supply module need not include a mechanism that translationally moves the nozzle. In this case, where one or more stationary nozzles drop ink into an ink supply path that opens at a specific position, the ink may be supplied into the ink storage part P while spreading the ink in the width direction by rotating of the doctor member or the auxiliary member. With such a configuration, the supply module can have a simplified structure, and the equipment cost can be reduced.

In the embodiments described above, the supply module is configured such that one nozzle reciprocates along the slot-type coating head. Alternatively, a plurality of nozzles may be disposed along the slot-type coating head. By disposing a plurality of nozzles in this way, time needed by ink to spread to the farthest part of the ink storage part P in the width direction can be easily reduced. The plurality of nozzles disposed in this way may each reciprocate along the slot-type coating head. By doing so, time needed by ink to spread to the farthest part of the ink storage part P in the width direction can be further reduced.

In the embodiments described above, the supply module includes the nozzle. Alternatively, ink may be supplied to the coating module by using a method that does not use a nozzle. For example, in the coating device of FIG. 6, ink may be applied to the peripheral surface of the auxiliary member by using a brush.

In each of the embodiments described above, the slot-type coating head spans the strip-shaped sheet in a direction perpendicular to the travel direction of the strip-shaped sheet. However, the span direction need not be perpendicular to the travel direction. Even when the slot-type coating head is disposed in this way, it is possible to prevent degradation of the quality of ink, because the slot-type coating head forms an ink storage part that can store ink on the strip-shaped sheet and that is substantially hermetically sealed.

### REFERENCE SIGNS LIST

1 travel module

2, 2a, 2b, 2c, 2d, 2e coating module

3 supply module

4, 4a, 4b, 4c, 4d, 4e slot-type coating head

5 first back-up roll

6 second back-up roll

7 back wall

8 front wall

9 upper wall

10 nozzle

11 reciprocating mechanism

12, 12d, 12e doctor member

13, 13b, 13c, 13d auxiliary member

14, 14d grooves

15, 15b, 15c inclined surface

16 side wall

17 upper wall

18 grooves

19, 19e inclined surface

20 film-thickness adjusting portion

21 sealing portion

22 inclined portion

D travel direction

F coating film

L ink supply path

P ink storage part

S strip-shaped sheet

θ inclination

1. A coating device comprising a travel module that causes a strip-shaped sheet to travel in a longitudinal direction, a coating module that coats a surface of the strip-shaped sheet with ink while the strip-shaped sheet travels, and a supply module that supplies the ink to the coating module,
wherein the coating module includes a slot-type coating head that is disposed above the strip-shaped sheet so as to span the strip-shaped sheet in a width direction, and
wherein the slot-type coating head includes an ink storage part that widens toward the strip-shaped sheet in cross-sectional view and an ink supply path that communicates with an upper part of the ink storage part.

2. The coating device according to claim 1, wherein the slot-type coating head includes a pair of bar-shaped members that are disposed parallel to each other and in such a way that upper parts thereof are adjacent to each other, and wherein a gap between the pair of bar-shaped members forms the ink storage part and the ink supply path.

3. The coating device according to claim 2, wherein at least one of the pair of bar-shaped members has a plurality of grooves in at least a lower part thereof, the grooves being parallel to a travel direction of the strip-shaped sheet.

4. The coating device according to claim 2, wherein at least one of the pair of bar-shaped members has an inclined surface at an upper part thereof, the inclined surface being inclined at an angle of depression in a direction toward the other bar-shaped member.

5. The coating device according to claim 1, wherein the supply module includes
a nozzle that drops the ink, and
a drive mechanism that reciprocates the nozzle along the slot-type coating head.

6. The coating device according to any one of claims 1 to 5 claim 1, wherein the travel module includes one or more back-up rolls that are configured to press the strip-shaped sheet against the slot-type coating head.

7. The coating device according to any claim 1, wherein the ink is solid dispersion type ink.

8. A method of producing a coated sheet, comprising a step of coating a surface of a strip-shaped sheet with ink by using the coating device according to claim 1.
